(19) United States
(12) Patent Application Publication
(10) Pub. No.: US 2004/0169893 A1
(43) Pub. Date: Sep. 2, 2004

(54) Method of transmitting and receiving fax data

(75) Inventor: Kang-hoon Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/436,375

(22) Filed: May 13, 2003

(30) Foreign Application Priority Data
May 13, 2002 (KR) 2002-26156

(51) Int. Cl. H04N 1/00; H04J 15/00

(52) U.S. Cl. 358/400; 358/411; 358/425

(57) ABSTRACT

A fax data transmitting and receiving method using a fax data transmitting apparatus and a fax data receiving apparatus that are connected via at least two fax lines. Upon fax data transmission, first, a script to be transmitted is scanned, and fax data corresponding to the script are stored. Next, at least two available lines to transmit the fax data are secured. Thereafter, the fax data is divided, and then the fax data segments are simultaneously transmitted via the secured available lines. Upon fax data reception, first, the dialing of the fax data transmitting apparatus is replied. Then, the phone number of at least one extra available line is provided to the fax data transmitting apparatus. Thereafter, an extra available line corresponding to the phone number is provided to the fax data transmitting apparatus. While fax data corresponding to a script is simultaneously received from the fax data transmitting apparatus via at least two available lines provided to the fax data transmitting apparatus, related data for classifying the fax data is also received. In this method, the speed of transmitting, receiving, and printing fax data increase, significantly reducing the time required to transmit fax and the time required to receive and print the fax data.

### CROSS-REFERENCE TO RELATED APPLICATIONS

This application claims the benefit of Korean Application No. 2002-26156, filed May 13, 2002, in the Korean Intellectual Property Office, the disclosure of which is incorporated herein by reference.

### BACKGROUND OF THE INVENTION

1. Field of the Invention

The present invention relates to a method of transmitting and receiving data using a facsimile (fax), and more particularly, to a method of transmitting and receiving fax data using a fax data transmitting apparatus and a fax data receiving apparatus that are connected via at least two fax lines. Hereinafter, a fax data transmitting and receiving apparatus having two fax lines is referred to as a dual line fax.

2. Description of the Related Art

Most fax data transmitting and receiving apparatuses are connected with at least one fax line. Such fax data transmitting and receiving apparatuses having multiple fax lines, theoretically, must provide a fax data transmission/reception speed obtained by multiplying the speed of fax data transmission or reception using a single fax line by the actual number of lines.

However, as described below, current apparatuses having such multiple fax lines have the same fax data transmission and reception speed as the speed of fax data transmission and reception apparatuses having a single fax line.

Typically, when a user transmits fax data from a fax data transmission and reception apparatus having one fax line (hereinafter, referred to as a single line fax) to another single line fax, transmission of the fax data is achieved as follows.

First, the single line fax at the user side sequentially scans a fax object (hereinafter referred to as a script) with multiple pages, and sequentially transmits the scanned pages in scanned order to the single line fax at the opposite side in a single job.

Upon fax data forwarding, and when fax data is transmitted to multiple single line faxes at one time, script pages are sequentially scanned and then transmitted to the multiple single line faxes by a single job.

In contrast, a dual line fax receives an individual job via each line, that is, receives different scripts. To be more specific, fax data is received from different fax data transmission and reception apparatuses via each line. Alternatively, the pages in a first script are sequentially received via one line in scanned order, and the pages in a second script independent of the first script are sequentially received via the other line in scanned order.

FIGS. 1 through 3 are flowcharts illustrating the steps of a conventional fax data transmitting method, respectively.

FIG. 1 shows a fax data transmission operation in a single line fax. First, script pages are scanned (S1) and the fax on the reception side is dialed (S2). The scanned script pages, that is, fax data, are sequentially transmitted in scanned order (S3).

FIG. 2 shows a fax data transmission operation in a dual line fax. First, scripts (e.g., a first script and a second script independent of the first script) are sequentially scanned (S4). The first and second fax lines in a receiving fax are sequentially dialed (S5 and S6). The fax data corresponding to the first script is sequentially transmitted via the first fax line in scanned order, and the fax data corresponding to the second script is sequentially transmitted via the second fax line in scanned order S7.

FIG. 3 shows a fax reception operation in a dual line fax. First, the receiving dual line fax responds to a first dialing to secure the first fax line of a transmission dual line fax (S100). Next, the dual line fax responds to a second dialing to secure the second fax line of a transmission dual line fax (S200). Thereafter, the dual line fax receives first fax data corresponding to the first script via the first fax line and also receives second fax data corresponding to the second script independent of the first script via the second fax line (S300). Then, the received fax data is sequentially printed out (S400).

In such a method of transmitting and receiving fax data using a conventional fax data transmission and reception apparatus, when a fax data transmission and reception apparatus having multiple lines is used, different fax data is transmitted or received via different lines. For example, first fax data is transmitted or received via a first line, and second fax data independent of the first fax data is transmitted or received via a second line. Accordingly, although a fax data transmission and reception apparatus having multiple fax lines is used, the time required to receive fax data is equal to that when a single line fax is used. To be more specific, although a conventional fax data transmission and reception apparatus has multiple fax data transmission and reception lines, it is just a simple combination of a plurality of separate fax lines. Therefore, there is no difference in the time required to transmit or receive fax data, as compared to a single line fax.

### SUMMARY OF THE INVENTION

Accordingly, it is an aspect of the present invention to provide a fax data transmitting method using a multi-line fax data transmitting and receiving apparatus, by which the transmission speed of fax data increases in proportion to the number of fax lines included in the multi-line fax data transmitting and receiving apparatus, such that the time for fax data transmission is reduced.

Another aspect of the present invention is to provide a fax data receiving method using a multi-line fax data transmitting and receiving apparatus, by which the speed of receiving fax data transmitted by the fax data transmitting method and the printing speed are increased, such that the time for fax data reception and the time for fax data printing are both reduced.

Additional aspects and/or advantages of the invention will be set forth in part in the description which follows and, in part, will be obvious from the description, or may be learned by practice of the invention.

The above and/or other aspects are achieved by providing a fax data transmitting method, which uses a fax data transmitting and receiving system in which a fax data transmitting apparatus and a fax data receiving apparatus are connected via at least two fax lines. In the fax data transmitting method, a script to be transmitted is scanned, and fax data corresponding to the script is stored. Thereafter, at least two available lines to transmit the fax data are secured. Next, the fax data is divided, and the fax data segments are simultaneously transmitted via the secured available lines.

The securing of the available lines includes dialing the identification number of the fax data receiving apparatus in order to connect the fax data receiving apparatus. Then, a phone number for at least one extra available line is requested from the fax data receiving apparatus. Thereafter, the phone number of the extra available line received from the fax data receiving apparatus is dialed in order to connect the fax data receiving apparatus.

The simultaneous dividing and transmitting of the fax data includes allocating a fax datum corresponding to a page selected from the pages of the script from among the stored fax data. The fax datum is allocated to an available line selected from the secured available lines, and a fax datum corresponding to the next page is also allocated to another available line selected from the secured available lines. Next, the two pieces of fax data allocated to their respective lines are simultaneously transmitted. Thereafter, the two previous operations are repeated until all of the stored fax data is transmitted.

As an alternative to the simultaneous dividing and transmitting of the fax data, first, a half of the stored fax data is allocated to an available line selected from the secured available lines, and the other half of the fax data is allocated to another available line selected from the secured available lines. Next, the fax data allocated to their respective lines is simultaneously transmitted.

The above and/or other aspects of the present invention may also be achieved by providing a fax data transmitting method, which uses a fax data transmitting and receiving system in which a fax data transmitting apparatus and a fax data receiving apparatus are connected via at least two fax lines. In the fax data transmitting method, at least two available lines to transmit fax data are secured. A script is scanned, and fax data corresponding to the script is stored. The stored fax data is divided, and the fax data segments are simultaneously transmitted via the secured available lines.

The above and/or other aspects of the present invention may also be achieved by providing a fax data receiving method using a fax data transmitting and receiving system in which a fax data transmitting apparatus and a fax data receiving apparatus are connected via at least two fax lines. In this method, there is a reply to the dialing of the fax data transmitting. The phone number of at least one extra available line is provided to the fax data transmitting apparatus at the request of the fax data transmitting apparatus, after the fax data transmitting apparatus is connected in response to the dialing. An extra available line corresponding to the phone number is provided to the fax data transmitting apparatus at the request of the fax data transmitting apparatus. Then, fax data corresponding to a script is simultaneously received from the fax data transmitting apparatus via at least two available lines provided to the fax data transmitting apparatus, and related data to classify the fax data is also received.

Furthermore, the simultaneously received fax data is classified by pages based on the related data, and the classified fax data is printed.

After the fax data associated with the script is all received, the received fax data is classified by pages based on the related data and then is printed on a page-by-page basis.

When the fax data associated with the script is not completely received, the received fax data is first classified by pages based on the related data and is then printed on a page-by-page basis.

The speed of transmitting the fax data and the speed of receiving and printing the transferred fax data increase in proportion to the number of lines included in a fax data transmitting apparatus and a fax data receiving apparatus. That is, the two speeds are increased compared to a conventional method of transmitting or receiving fax data corresponding to one script via one line. Consequently, the time required to transmit fax data and the time required to receive and print the fax data are significantly reduced.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIGS. 1 and 2 are flowcharts illustrating a fax data transmitting method using a conventional single line fax and a fax data transmitting method using a conventional dual line fax, respectively;

FIG. 3 is a flowchart illustrating a fax receiving method using a conventional dual line fax;

FIG. 4 is a flowchart illustrating a fax data transmitting method according to a first embodiment of the present invention;

FIGS. 5 and 6 are flowcharts illustrating first and second examples, respectively, of a process of dividing and transmitting fax data at the same time in the fax data transmitting method of FIG. 4;

FIG. 7 is a flowchart illustrating a fax data transmitting method according to a second embodiment of the present invention; and

FIG. 8 is a flowchart illustrating a fax data receiving method according to an embodiment of the present invention.

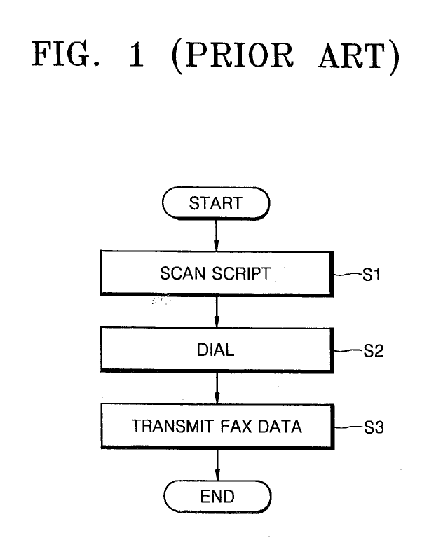

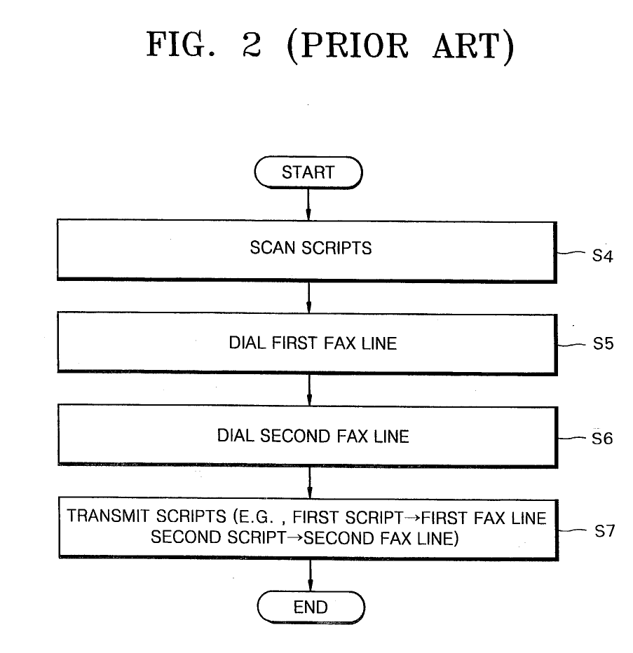

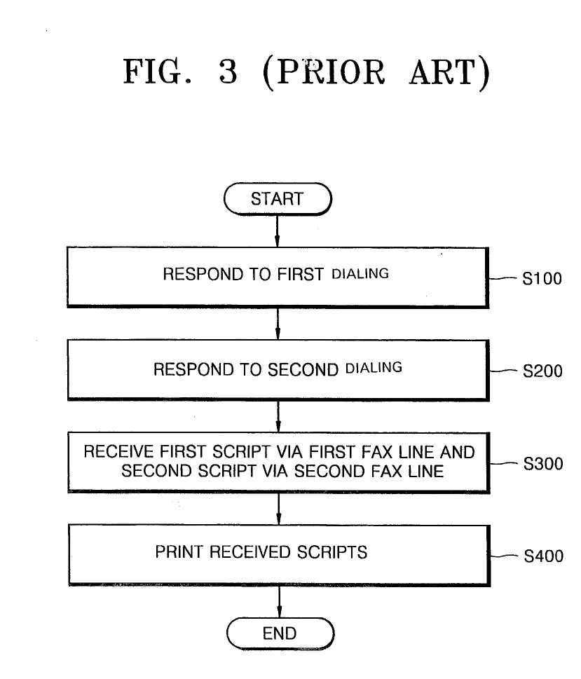

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

The method of transmitting and receiving fax data according to the embodiments of the present invention uses a single fax data transmission and reception apparatus having at least two fax lines. However, for convenience sake, a method of transmitting and receiving fax data using a dual line fax including two fax lines will now be described.

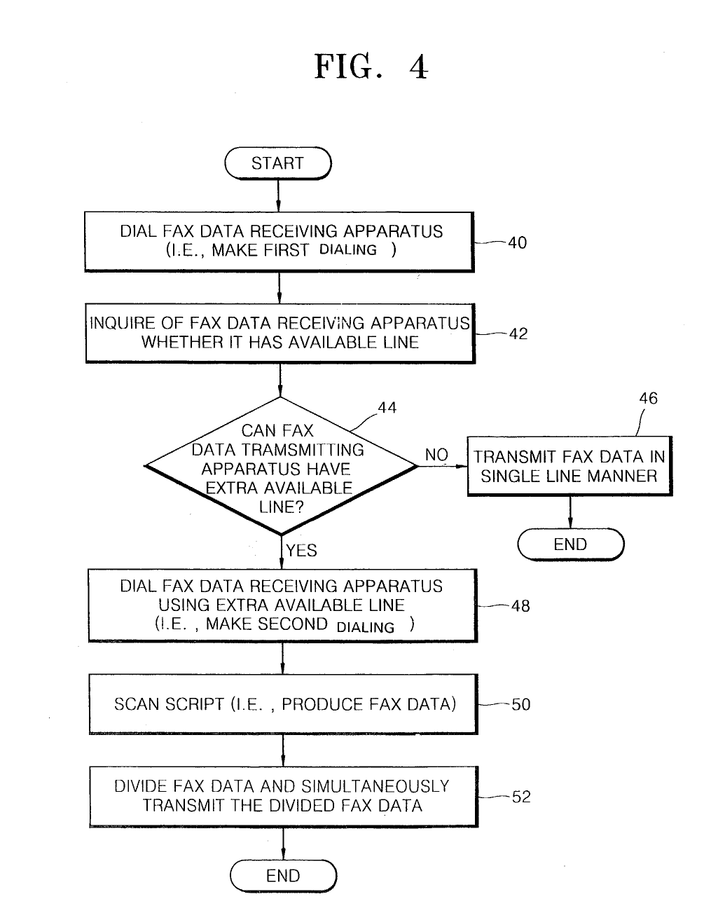

A fax data transmitting method according to a first embodiment of the present invention is illustrated in FIG. 4. Referring to FIG. 4, first, a script is put on a fax data transmitting apparatus and then an identification number of a fax data receiving apparatus (fax) to receive the script from a user, for example, the number of the fax data receiving apparatus, is input. The fax data transmitting apparatus dials the fax data receiving apparatus using the input number (hereinafter referred to as a first phone number), which is referred to as a first dialing hereinafter (operation 40). When the fax data transmitting apparatus is connected to the fax data receiving apparatus, it inquires of the fax data receiving apparatus whether it has available lines (operation 42).

When the available lines of the fax data receiving apparatus are all used, or not connected for other reasons upon the first dialing, a message, such as “line busy”, is externally displayed, or an alarm is generated together with the message, so that the user can be informed of the status of the available lines.

Thereafter, it is checked whether the fax data transmitting apparatus can have an extra available line (operation 44). If the fax data transmitting apparatus cannot have extra available lines (for example, if it actually has no extra available lines or has an extra available line but its estimated free time is longer than a predetermined time), the fax data transmitting apparatus transmits fax data associated with the script in a single line manner, using only the lines corresponding to the first phone number (operation 46).

On the other hand, if the fax data transmitting apparatus can have an extra available line, the fax data transmitting apparatus dials the fax data receiving apparatus again using a phone number for the extra available line received from the fax data receiving apparatus (operation 48). Hereinafter, the phone number of the extra available line is referred to as a second phone number, and the dialing action (operation 48) is referred to as a second dialing. Consequently, two available lines with the first and second phone numbers, respectively, are secured.

Thereafter, the fax data transmitting apparatus scans the entire script (operation 50). Fax data produced through scanning is stored in a memory in the fax data transmitting apparatus. The fax data transmitting apparatus divides the stored fax data, and transmits some of the fax data via the first line of the two secured lines and at the same time transmits the rest via the second line (operation 52).

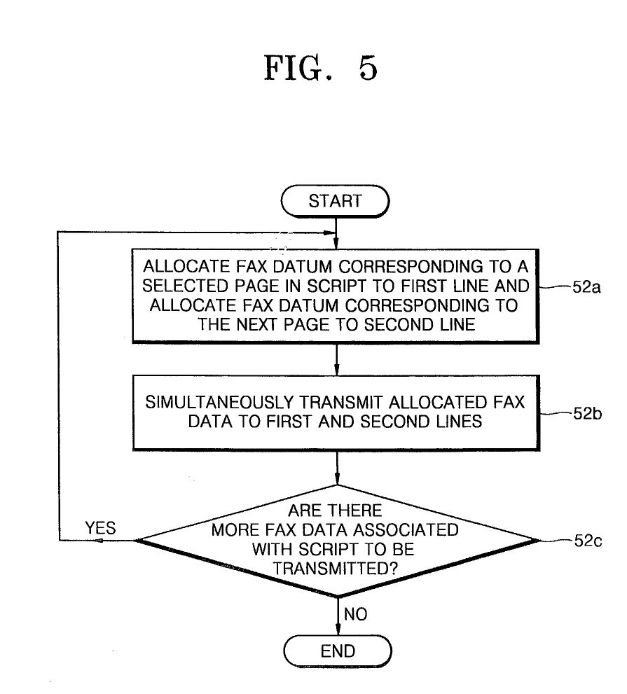

In a first example of operation 52, as shown in FIG. 5, a fax datum corresponding to a selected page (for example, the first page) in the script, among the stored fax data, is allocated to the first line, and a fax datum corresponding to the next page is allocated to the second line, in operation 52a. Next, the allocated fax data is simultaneously transmitted via the respective first and second lines, in operation 52b. Thereafter, it is determined whether the fax data associated with the script remains in the memory of the fax data transmitting apparatus, in operation 52c. If the fax data associated with the script remains, operations 52a and 52b repeat until the remaining fax data is all transmitted. If no more fax data associated with the script remains, the operation is concluded.

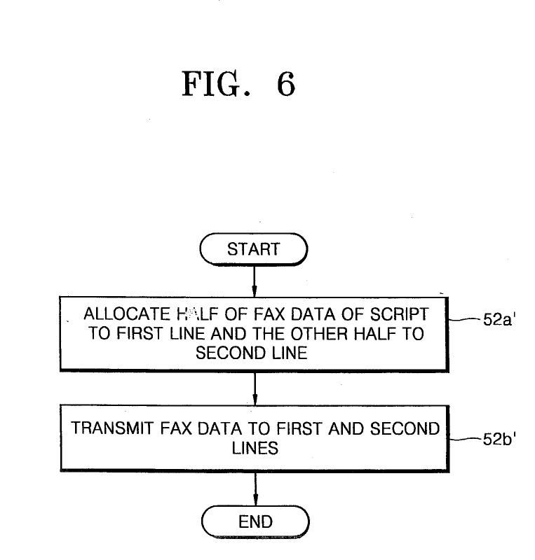

In a second example of operation 52, as shown in FIG. 6, fax data corresponding to a first half of the script, among the stored fax data, is allocated to the first line, and the rest of the stored fax data is allocated to the second line, in step 52a′. For example, the first half of the script is the first through fifth pages when the total is 10 pages. Next, the first half of the fax data is sequentially transmitted via the corresponding line and at the same time the second half is sequentially transmitted via the corresponding line, in operation 52b′.

After all of the fax data is transmitted, the operation is completed.

While the fax data corresponding to the script is transmitted, the fax data transmitting apparatus informs the fax data receiving apparatus of the IDs of the fax data and the script page numbers corresponding to the fax data transmitted via the respective lines.

In a fax data transmitting method according to a second embodiment of the present invention, to be described hereinafter, the script-scanning operation 50 is performed before the first dialing.

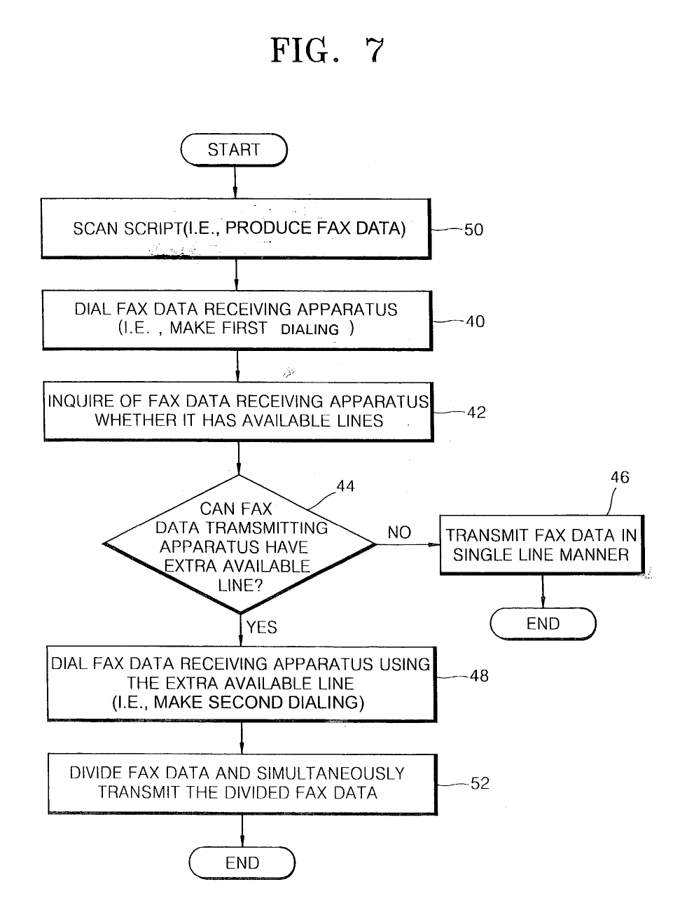

Referring to FIG. 7, after a script to transmit fax data is put on a fax data transmitting apparatus, and a user inputs the ID number of a fax data receiving apparatus (i.e., a fax number), the pages in the script are all scanned and the scanning results are stored in a memory, in operation 50. The subsequent operations are performed in the same order as in the first embodiment, except the scanning operation 50 is not performed after the second dialing operation 48, since the script is scanned before the first dialing.

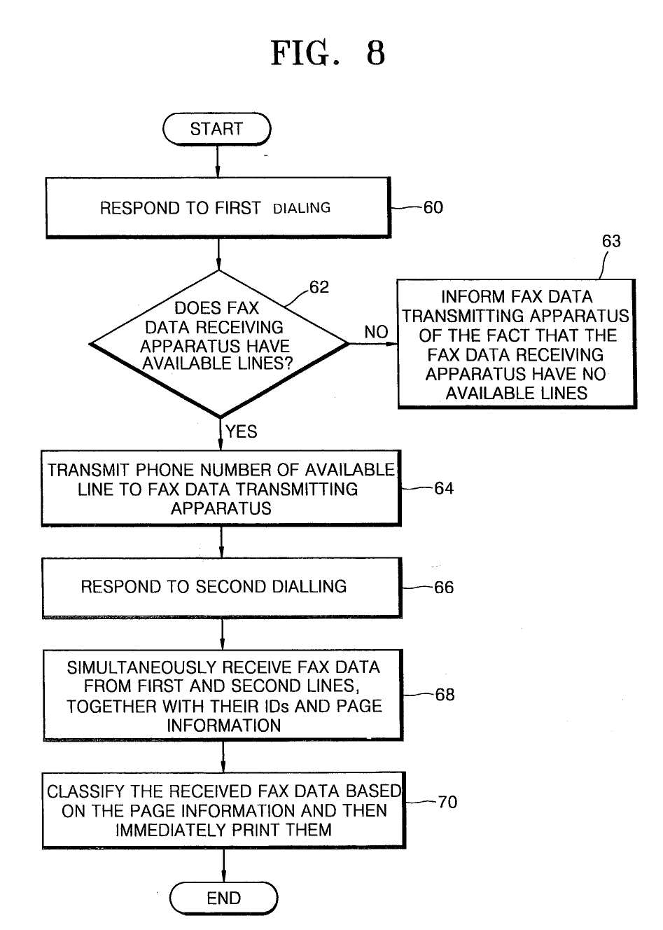

Hereinafter, a method of receiving the fax data transmitted by the fax data transmitting method will be described with reference to FIG. 8. First, the fax data receiving apparatus responds to the first dialing from the fax data transmitting apparatus, in operation 60. Next, it is determined whether the fax data receiving apparatus has available lines, in operation 62.

If it is determined in operation 62 that the fax data receiving apparatus has no available lines or it has available lines but they are unavailable, this fact is reported to the fax data transmitting apparatus, in operation 63.

If it is determined in operation 62 that the fax data receiving apparatus has an available line, the phone number of the available line (hereinafter referred to as a second phone number) is transmitted to the fax data transmitting apparatus, in operation 64. Thereafter, the fax data receiving apparatus responds to the second dialing using the second phone number from the fax data transmitting apparatus, in operation 66. While the fax data receiving apparatus simultaneously receives first fax data from the fax data transmitting apparatus via the lines having the first and second phone numbers (hereinafter referred to as the first and second lines), it also receives the ID and page information of the received first fax data, in operation 68. Then, the fax data receiving apparatus compares the fax data received via the first and second lines with each other based on the page information so as to classify them in page order, and is then immediately printed, in operation 70.

To be more specific, if a fax datum corresponding to a selected page (i.e., a first page) in the script is received via the first line and, at the same time, a fax datum corresponding to a second page in the script is received via the second line, it is checked through comparison of the received page information that the fax datum received via the first line corresponds to the first page of the script, and the fax datum received via the second line corresponds to the second page of the script. Thereafter, the fax datum received via the first line is first printed, and the fax datum received via the second line is then printed. Instead of first classifying first-received fax data based on the page information and then printing, classification is performed based on the page information received together with the fax data after the fax data corresponding to the script are all received via the first and second lines.

If fax data corresponding to the half of the script is consecutively received via the first line, and simultaneously fax data corresponding to the other half of the script is consecutively received via the second line, the received fax data are compared with each other based on the page information received together with the fax data, and are then classified by pages, as described above. The classified pages are immediately printed without waiting for the fax data to be completely received.

Although the fax data transmitting apparatus and the fax data receiving apparatus are both a fax data transceiving apparatus that can transmit and receive fax data, they have been described above as different apparatuses for convenience sake.

Although a few preferred embodiments of the present invention have been shown and described, it will be appreciated by those skilled in the art that changes may be made in these embodiments without departing from the principles and spirit of the invention, the scope of which is defined in the claims and their equivalents.

For example, instead of transmission of fax data on a page-by-page basis, transmission on a line-by-line is also possible. That is, the first line on the first page is transmitted via the first line, and simultaneously the second line on the same page is transmitted via the second line. The script may be put on a fax data receiving apparatus and scanned after the fax data receiving apparatus is dialed. Instead of scanning the entire script, part of the script may be scanned first, and the rest may be then scanned, during which the firstly scanned part is divided and the segments are simultaneously transmitted. Accordingly, various changes in form and details may be made without departing from the spirit and scope of the present invention as defined by the appended claims.

As described above, in a fax data transmitting and receiving method according to the present invention, a script to be transmitted is divided into pages, and the pages are simultaneously transmitted via at least two fax lines to connect a fax data transmitting apparatus to a fax data receiving apparatus. Fax data corresponding to the transmitted pages are simultaneously received via the two fax lines and are then printed. The speed of transmission of fax data and the speed of receiving and printing the transferred fax data increase in proportion to the number of lines included in the fax data transmitting apparatus and the fax data receiving apparatus. That is, the two speeds are increased compared to a conventional method of transmitting or receiving fax data corresponding to one script via one line. Consequently, the time required to transmit fax data and the time required to receive and print the fax data are significantly reduced.

What is claimed is:

1. A fax data transmitting method using a fax data transmitting and receiving system including a fax data transmitting apparatus and a fax data receiving apparatus connected via two available fax data transmitting and receiving lines, the method comprising:
scanning a script, comprising pages, to be transmitted and storing fax data corresponding to the script;
securing the two available lines to transmit the stored fax data; and
dividing the stored fax data into a plurality of segments and simultaneously transmitting the divided fax data via the secured available lines.

2. The fax data transmitting method of claim 1, wherein the securing comprises:
dialing an identification number of the fax data receiving apparatus to connect the fax data transmitting apparatus and the fax data receiving apparatus;
requesting a phone number of an extra available line from the fax data receiving apparatus; and
dialing the phone number of the extra available line requested from the fax data receiving apparatus to connect the fax data transmitting apparatus and the fax data receiving apparatus.

3. The fax data transmitting method of claim 1, wherein the dividing comprises:
allocating a fax datum corresponding to a page selected from the pages of the script, from among the stored fax data, to a first line selected from the secured available lines, and allocating a fax datum corresponding to the next page of the script to a second line selected from the secured available lines;
simultaneously transmitting the allocated fax data via the first and second lines; and
repeating the allocating and simultaneous transmitting until all of the stored fax data is transmitted.

4. The fax data transmitting method of claim 1, wherein the dividing comprises:
allocating a first half of the stored fax data to a first line selected from the secured available lines, and allocating a second half of the stored fax data to a second line selected from the secured available lines; and
simultaneously transmitting the allocated fax data via the first and second selected lines.

5. The fax data transmitting method of claim 1, wherein the simultaneous transmitting comprises simultaneously transmitting the divided fax data together with identifications of the fax data and page information on the fax data.

6. The fax data transmitting method of claim 3, wherein the simultaneous transmitting comprises simultaneously transmitting the divided fax data together with identifications of the fax data and page information on the fax data.

7. The fax data transmitting method of claim 4, wherein the simultaneous transmitting of the divided fax data comprises simultaneously transmitting the divided fax data together with identifications of the fax data and page information on the fax data.

8. A fax data transmitting method using a fax data transmitting and receiving system including a fax data transmitting apparatus and a fax data receiving apparatus connected via two available fax data transmitting and receiving lines, the method comprising:
securing the two available lines to transmit fax data;
scanning a script corresponding to the fax data, comprising pages, and storing the fax data corresponding to the script; and
dividing the stored fax data and simultaneously transmitting the divided fax data via the secured available lines.

9. The fax data transmitting method of claim 8, wherein the securing comprises:
dialing an identification number of the fax data receiving apparatus to connect the fax data receiving apparatus with the fax data transmitting apparatus;
requesting a phone number for an extra available line from the fax data receiving apparatus; and
dialing the requested phone number to connect the fax data receiving apparatus with the fax data transmitting apparatus.

10. The fax data transmitting method of claim 8, wherein the dividing comprises:
allocating a fax datum corresponding to a page selected from the pages of the script, from among the stored fax data, to a first line selected from the secured available lines, and allocating a fax datum corresponding to the next page of the script to a second available line selected from the secured available lines;
simultaneously transmitting the allocated fax data via the first and second lines; and
repeating the allocating and simultaneous transmitting of the allocated data until all of the stored fax data is transmitted.

11. The fax data transmitting method of claim 8, wherein the dividing comprises:
allocating a first half of the stored fax data to a first line selected from the secured available lines, and allocating a second half of the stored fax data to a second line selected from the secured available lines; and
simultaneously transmitting the allocated fax data via the first and second selected lines.

12. The fax data transmitting method of claim 8, wherein the simultaneous transmitting comprises simultaneously transmitting the divided fax data together with identifications of the fax data and page information on the fax data.

13. The fax data transmitting method of claim 10, wherein the simultaneous transmitting of the divided fax data comprises simultaneously transmitting the divided fax data together with identifications of the fax data and page information on the fax data.

14. The fax data transmitting method of claim 11, wherein the simultaneous transmitting of the divided data comprises simultaneously transmitting the divided fax data together with identifications of the fax data and page information on the fax data.

15. A fax data receiving method using a fax data transmitting and receiving system including a fax data transmitting apparatus and a fax data receiving apparatus connected via two available fax data transmitting and receiving lines, the method comprising:
responding to a dialing of the fax data transmitting apparatus comprising connecting the fax data transmitting apparatus and the fax data receiving apparatus;
providing a phone number of an extra available line to the fax data transmitting apparatus at a request of the fax data transmitting apparatus;
providing the extra available line to the fax data transmitting apparatus at a request of the fax data transmitting apparatus; and
simultaneously receiving fax data corresponding to a script from the fax data transmitting apparatus via the two available lines provided to the fax data transmitting apparatus, and receiving related data to classify the fax data.

16. The fax data receiving method of claim 15, further comprising:
classifying the simultaneously received fax data by pages based on the related data; and
printing the classified fax data.

17. The fax data receiving method of claim 16, wherein, the classifying is performed after the fax data corresponding to the script is received, and the printing comprises printing on a page-by-page basis.

18. The fax data receiving method of claim 16, wherein, in a state in which the fax data corresponding to the script is not completely received, the classifying is performed and the received fax data is then printed on a page-by-page basis.

19. The fax data receiving method of claim 16, wherein the related data comprises an identification of the script and the page information on the script.

20. A fax data transmitting method comprising:
dividing fax data; and
simultaneously transmitting the divided fax data from a transmitting apparatus to a single receiving apparatus via a plurality of lines.

21. The method of claim 20, further comprising:
scanning a script, comprising pages corresponding to the fax data; and
dialing the receiving apparatus to connect the transmitting and receiving apparatuses.

22. The method of claim 20, wherein the dividing comprises dividing the fax data into a plurality of pages.

23. The method of claim 20, wherein the dividing comprises dividing the fax data into a first half and a second half.

24. The method of claim 21, wherein the scanning is performed before the dialing.

25. The method of claim 21, wherein the scanning is performed after the dialing.

26. The method of claim 21, further comprising classifying the transmitted fax data according to the pages.
